(19) United States
(12) Patent Application Publication
(10) Pub. No.: US 2021/0144217 A1
(43) Pub. Date: May 13, 2021

(54) SERVICE COMMUNICATION PROXY APPARATUS AND METHOD

(71) Applicant: Institute For Information Industry, Taipei (TW)

(72) Inventor: Ming-Chun LIU, Taipei (TW)

(21) Appl. No.: 16/701,109

(22) Filed: Dec. 2, 2019

(30) Foreign Application Priority Data
Nov. 13, 2019 (TW) 108141214

(51) Int. Cl. H04L 29/08

(52) U.S. Cl. CPC H04L 67/16; H04L 67/147; H04L 67/28; H04L 67/1097

(57) ABSTRACT

A service communication proxy apparatus and method are provided. The service communication proxy apparatus receives a service request from a first entity of a core network and sends a discovery request to a second entity in the core network according to a network function indicated in the service request. The second entity has a network repository function. The service communication proxy apparatus receives a discovery response related to the network function from the second entity and redirects the service request to a third entity in the core network according to an identity message indicated in the discovery response. The service communication proxy apparatus receives a service response from the third entity, records a mapping record regarding the first entity and the third entity, and redirects the service response to the first entity.

### PRIORITY

This application claims priority to Taiwan Patent Application No. 108141214 filed on Nov. 13, 2019, which is hereby incorporated by reference in its entirety.

### FIELD

The present invention relates to a service communication proxy apparatus and method. In particular, the present invention relates to a service communication proxy apparatus and method for a core network.

### BACKGROUND

At present, research and development personnel and mobile communication providers around the world are actively developing specifications for the Fifth Generation (5G) of mobile communication systems. According to the latest specification (i.e., the Release 16 (R16) of the specification) proposed by the 3rd Generation Partnership Project (3GPP), if a network function consumer and a network function publisher in the core network need to communicate with each other, they have to interact with each other through a service communication proxy (SCP) and a network repository function (NRF) first and the communication therebetween is then redirected by the service communication proxy.

According to the R16 of the specification, the above procedure must be performed no matter the network function requested by the network function consumer is repeated or not. As a result, there will be tremendous interactions between the service communication proxy and the network repository function, which causes a considerable burden to both the service communication proxy and the network repository function. Accordingly, for the fifth generation of mobile communication system, it is an urgent task to improve the performance of the core network by refining the operations between the service communication proxy and the network repository function.

### SUMMARY

To solve the above technical problems in the fifth generation of mobile communication systems, Provides a service communication proxy (SCP) apparatus and method are provided.

The service communication proxy apparatus may comprise a storage and a processor, wherein the processor and the storage are electrically connected with each other. The processor receives a service request from a first entity in a core network and sends a discovery request to a second entity in the core network in response to a network function indicated in the service request, wherein the second entity has a network repository function (NRF). The processor further receives a discovery response related to the network function from the second entity and redirects the service request to a third entity in the core network according to an identity message indicated in the discovery response. The processor further receives a service response from the third entity, records a mapping record regarding the first entity and the third entity in the storage, and redirects the service response to the first entity.

The service communication proxy method is adapted for use in an electronic computing apparatus. The service communication proxy method may comprise the following steps: (a) receiving a service request from a first entity in a core network, (b) sending a discovery request to a second entity in the core network in response to a network function indicated in the service request, wherein the second entity has a network repository function, (c) receiving a discovery response related to the network function from the second entity, (d) redirecting the service request to a third entity in the core network according to an identity message indicated in the discovery response, (e) receiving a service response from the third entity, (f) recording a mapping record regarding the first entity and the third entity in the electronic computing apparatus, and (g) redirecting the service response to the first entity.

The service communication proxy technology (at least including the apparatus and the method) stores a mapping record regarding a network function consumer (e.g., the aforementioned first entity) and a network function publisher (e.g., the aforementioned third entity). If the network function consumer makes a service request for the same network function again, the service communication proxy technology provided by the present invention redirects the service request to the corresponding network function publisher according to the previously stored mapping record. By storing the mapping record regarding the network function consumer and the network function publisher, the service communication proxy technology does not need to frequently interact with the network repository function. Thereby, the communication load between the entities in the core network is reduced and the communication delay between the entities in the core network is mitigated. As a result, the performance of the core network is improved.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A depicts a schematic view of a service communication proxy apparatus 11 according to some embodiments of the present invention;

FIG. 1B depicts a schematic view of a fifth generation of mobile communication system;

FIG. 1C depicts a schematic view of the signal transmission in the first embodiment;

FIG. 2 depicts a schematic view of the signal transmission in the second embodiment;

FIG. 3 depicts a schematic view of the signal transmission in the third embodiment;

FIG. 4 depicts a schematic view of the signal transmission in the fourth embodiment;

FIG. 5A depicts the main flowchart of a fifth embodiment;

FIG. 5B depicts a partial flowchart of the service communication proxy method according to some embodiments of the present invention; and

FIG. 5C depicts a partial flowchart of the service communication proxy method according to some embodiments of the present invention.

### DETAILED DESCRIPTION

In the following description, a service communication proxy apparatus and method will be explained with reference to certain example embodiments thereof. However, these example embodiments are not intended to limit the present invention to any specific environment, example, embodiment, applications, or implementations described in these example embodiments. Therefore, description of these example embodiments is only for purpose of illustration rather than to limit the scope of the present invention.

It should be appreciated that, in the following embodiments and the attached drawings, elements unrelated to the present invention are omitted from depiction. In addition, dimensions of and dimensional scales between individual elements in the attached drawings are provided only for ease of depiction and illustration, but not to limit the scope of the present invention.

A first embodiment of the present invention is a service communication proxy apparatus 11 and a schematic view of which is depicted in FIG. 1A. The service communication proxy apparatus 11 comprises a storage 111 and a processor 113, wherein the storage 111 and the processor 13 are electrically connected with each other. The storage 111 may be a memory, a hard disk drive (HDD), a universal serial bus (USB) disk, a compact disk (CD), or any other non-transitory storage medium or apparatus having the same function and well-known to a person having ordinary skill in the art. The processor 113 may be one of various processors, central processing units (CPUs), microprocessor units (MPUs), digital signal processors (DSPs), or any other computing apparatuses having the same function and well-known to a person having ordinary skill in the art.

The service communication proxy apparatus 11 belongs to a core network of a fifth generation of mobile communication system. For comprehension, please refer to the schematic view of a fifth generation of mobile communication system depicted in FIG. 1B. The fifth generation of mobile communication system comprises a user equipment (UE), a radio access network (RAN), and the core network. The core network provides a plurality of network functions, and each of the network functions is individually executed by an entity. Each entity may be realized by software (e.g., a virtual machine) or hardware (e.g., a server, a desktop computer, and a notebook computer, without being limited thereto). When each entity is realized by the software, the software of these entities may be executed on the same hardware (for example, may be simultaneously executed on the service communication proxy apparatus 11) or may be executed on different hardware.

As shown in FIG. 1B, each of the network functions provided by the core network may be a Network Slice Selection Function (NSSF), a Network Exposure Function (NEF), a Network Repository Function (NRF), a Policy and Charge Function (PCF), a User Data Management (UDM), an Application Function (AF), an Authentication Server Function (AUSF), an Accessible and Mobility Function (AMF), a Service Management Function (SMF), a User Plane Function (UPF), or a Data Network (DN) in the fifth generation of mobile communication system, but it is not limited thereto. Each entity will register its network function to the entity that executes the network repository function after being activated. Therefore, the entity that executes the network repository function knows which entity provides which network function.

In this embodiment, the service communication proxy apparatus 11 improves the service communication proxy (SCP) function provided by the fifth generation of mobile communication system. The specific operations performed by the service communication proxy apparatus 11 will be described in details below.

Please refer to FIG. 1C, which depicts the schematic view of the signal transmission of this embodiment. In this embodiment, the core network comprises the service communication proxy apparatus 11 and the entities 13, 15, and 17. Each of the entities 13, 15, and 17 performs a network function, wherein the network function performed by the entity 15 is the network repository function (i.e., the entity 15 knows which entity in the core network provides which network function).

At some time point, the entity 13 needs a certain network function (e.g., the accessible and mobility function), so the entity 13 sends a service request 100 to the service communication proxy apparatus 11, wherein the service request 100 records the network functions required by the entity 13. Since the entity 13 has made the service request 100, the entity 13 can be considered as a network function consumer. The processor 113 receives the service request 100 from the entity 13 and determines whether the storage 111 has any mapping record (will be detailed later) that is related to both the entity 13 and the network function required by the entity 13. Herein, it is assumed that the processor 113 determines that the storage 111 does not have any mapping record related to both the entity 13 and the network function required by the entity 13. Based on this determination result, the processor 113 sends a discovery request 102 to the entity 15 in response to the network function indicated by the service request 100 (that is, the network function required by the entity 13), wherein the discovery request 102 records the network function required by the entity 13.

In some other embodiments, if the processor 113 is able to know that the entity 13 is making the request for the network function for the first time, the processor 113 may directly send the discovery request 102 to the entity 15 without determining whether the storage 111 has any mapping record that is related to both the entity 13 and the network function required by the entity 13.

Next, the processor 113 receives a discovery response 104 related to the network function from the entity 15, wherein the discovery response 104 records which entity/entities in the core network provides/provide the network function (e.g., records an identity message of each entity that provides the network function). For convenience, it is assumed that the discovery response 104 records that the entity 17 provides the network function. Since the entity 17 provides the network function, the entity 17 can be considered as a network function publisher. After receiving the discovery response 104, the processor 113 redirects the service request 100 of the entity 13 to the entity 17 according to the identity message (e.g., the identification code of the entity 17, the Internet Protocol (IP) address of the entity 17, without being limited thereto) indicated in the discovery response 104.

In response to the service request 100, the entity 17 sends a service response 108. The processor 113 of the service communication proxy apparatus 11 receives the service response 108 from the entity 17 and records a mapping record 10 regarding the entity 13 and the entity 17 in the storage 111. The mapping record 10 is used to indicate that the entity 13 has been provided with the service of the network function by the entity 17. For example, the contents of the mapping record 10 may comprise the identification information of the entity 13 and identification information of the entity 17. After receiving the service response 108 from the entity 17, the processor 113 redirects the service response 108 to the entity 13.

At a later time, the processor 113 receives another service request 112 from the entity 13, wherein the network function recorded in the service request 112 is the same as the network function recorded in the service request 100 (e.g., both service requests recording the accessible and mobility function). Next, the processor 113 finds out that the mapping record 10 in the storage 111 is related to the entity 13 and the entity 17 having the network function. Since the mapping record 10 is found in the storage 111 of the service communication proxy apparatus 11, the processor 113 will not request the entity 15 to discover which entity/entities in the core network provides/provide the requested network function. Instead, the processor 113 directly redirects the service request 112 to the entity 17 according to the identity message of the entity 17 recorded in the mapping record 10. Similarly, in response to the service request 112, the entity 17 sends a service response 116. The processor 113 of the service communication proxy apparatus 11 receives the service response 116 from the entity 17 and redirects the service response 116 to the entity 13.

From the above description, it is learned that the service communication proxy apparatus 11 will store the mapping record regarding a network function consumer (e.g., the entity 13) and a network function publisher (e.g., the entity 17). Therefore, if the network function consumer makes a service request for the same network function again, the service communication proxy apparatus 11 will directly redirect the service request to the corresponding network function publisher according to the previously stored mapping record. By recording the mapping record regarding the network function consumer and the network function publisher, the service communication proxy apparatus 11 does not need to frequently interact with the network repository function. Thereby, the communication load between the entities in the core network is reduced and the communication delay between the entities in the core network is mitigated. As a result, the performance of the core network is improved.

Please refer to FIG. 1A and FIG. 2 for a second embodiment of the present invention, wherein FIG. 2 depicts the schematic view of the signal transmission in this embodiment. The second embodiment is similar to the first embodiment. However, in this embodiment, each network function publisher in the core network periodically reports its status to the entity 15. If the entity 15 has not received a report from a certain network function publisher for more than a preset period of time, the entity 15 will treat that network function publisher as being invalid and then notify the service communication proxy apparatus 11. After learning that a network function publisher has become invalid, the service communication proxy apparatus 11 deletes the mapping record related to that network function publisher. The following description will focus on the differences between the second embodiment and the first embodiment.

Herein, it is assumed that the service communication proxy apparatus 11 has redirected the service response 108 replied by the entity 17 to the entity 13 in response to the service request 100 made by the entity 13. At a later time, the processor 113 receives a notification message 120 from the entity 15, wherein the notification message 120 indicates that the entity 17 is invalid. In response to the fact that the entity 17 is invalid, the processor 113 deletes all the mapping records (e.g., the aforementioned mapping record 10) related to the entity 17 from the storage 111.

At a later time, the processor 113 receives another service request 122 from the entity 13, and the network function recorded in the service request 122 is the same as the network function recorded in the service request 100 (e.g., both service requests recording the accessible and mobility function). The processor 113 finds out that no mapping record in the storage 111 is related to both the entity 13 and the network function required by the entity 13 (because the mapping record 10 has been deleted). Based on this determination result, the processor 113 sends a discovery request 124 to the entity 15 in response to the network function indicated by the service request 122 (that is, the network function required by the entity 13), wherein the discovery request 124 records the network function required by the entity 13.

Next, the processor 113 receives a discovery response 126 related to the network function from the entity 15, wherein the discovery response 126 records which entity/entities in the core network provides/provide the network function (e.g., records an identity message of each entity that provides the network function). For convenience, it is assumed that the discovery response 126 records that the entity 19 provides the network function. Since the entity 19 provides the network function, the entity 19 is considered as a network function publisher. After receiving the discovery response 126, the processor 113 redirects the service request 122 of the entity 13 to the entity 19 according to the identity message (e.g., the identification code of the entity 19, the IP address of the entity 19, without being limited thereto) indicated by the discovery response 126.

In response to the service request 122, the entity 19 sends a service response 130. The processor 113 of the service communication proxy apparatus 11 receives the service response 130 from the entity 19 and records a mapping record 12 regarding the entity 13 and the entity 19 in the storage 111. The mapping record 12 is used to indicate that the entity 13 has been provided with the service of the network function by the entity 19. For example, the contents of the mapping record 12 may comprise the identification information of the entity 13 and the identification information of the entity 19. After receiving the service response 130 from the entity 19, the processor 113 redirects the service response 130 to the entity 13.

From the above description, it is learned that, in this embodiment, if a certain network function publisher has become invalid, the entity 15 will notify the service communication proxy apparatus 1 so that the service communication proxy apparatus 11 can delete the mapping record related to the network function publisher accordingly. In this way, the correctness of the mapping record stored by the service communication proxy apparatus 11 is ensured.

Please refer to FIG. 1A and FIG. 3 for a third embodiment of the present invention, wherein FIG. 3 depicts the schematic view of the signal transmission in this embodiment. The third embodiment is similar to the first embodiment. However, in this embodiment, each mapping record further comprises a live time stamp. Therefore, in this embodiment, the processor 113 of the service communication proxy apparatus 11 will determine whether a mapping record has expired according to the live time stamp of the mapping record. If the processor 113 determines that a mapping record has expired, the processor 113 deletes the mapping record from the storage 111. The following description will focus on the differences between the third embodiment and the first embodiment.

Herein, it is assumed that the service communication proxy apparatus 11 has redirected the service response 108 replied by the entity 17 to the entity 13 in response to the service request 100 made by the entity 13. At a later time, the processor 113 receives another service request 132 from the entity 13, and the network function recorded in the service request 132 is the same as the network function recorded in the service request 100 (e.g., both service request recording the accessible and mobility functions).

Next, the processor 113 finds out that the mapping record 10 in the storage 111 is related to the entity 13 and the entity 17 having the network function from the storage 111. The processor 113 further determines whether the mapping record 10 has expired according to the live time stamp T1 of the mapping record 10. It shall be noted that the form of the live time stamp T1 is not limited by the present invention. For example, the live time stamp T1 may be a preset length of time. In that case, if the processor 113 determines that the mapping record 10 has been stored in the storage 111 for more than the preset length of time, it means that the mapping record 10 has expired. As another example, the live time stamp T1 may be an expiration time point. In that case, if the processor 113 determines that the current time point (e.g., the time point at which the service request 132 is received) is later than the expiration time point, it means that the mapping record 10 has expired.

Herein, it is assumed that the processor 113 determines that the mapping record 10 has expired according to the live time stamp T1 of the mapping record 10 and, hence, the processor 113 deletes the mapping record 10 from the storage 111. Since no mapping record in the storage 111 is related to both the entity 13 and the network function required by the entity 13, the service communication proxy apparatus 11 will discover the network function again. Specifically, the processor 113 sends a discovery request 134 to the entity 15 in response to the network function indicated by the service request 132 (that is, the network function required by the entity 13), wherein the discovery request 134 records the network function required by the entity 13.

Next, the processor 113 receives a discovery response 136 related to the network function from the entity 15, wherein the discovery response 136 records which entity/entities in the core network provides/provide the network function (e.g., records an identity message of each entity that provides the network function). For convenience, it is assumed that the discovery response 136 records that the entity 19 provides the network function. Since the entity 19 provides the network function, the entity 19 is considered as a network function publisher. After receiving the discovery response 136, the processor 113 redirects the service request 132 of the entity 13 to the entity 19 according to the identity message (e.g., the identification code of the entity 19, the IP address of the entity 19, without being limited thereto) indicated by the discovery response 136.

In response to the service request 132, the entity 19 sends a service response 140. The processor 113 of the service communication proxy apparatus 11 receives the service response 140 from the entity 19 and records a mapping record 12 regarding the entity 13 and the entity 19 in the storage 111. The mapping record 12 also comprises a live time stamp. The mapping record 12 is used to indicate that the entity 13 has been provided with the service of the network function by the entity 19. For example, the contents of the mapping record 12 may comprise the identification information of the entity 13 and the identification information of the entity 19. After receiving the service response 140 from the entity 19, the processor 113 redirects the service response 140 to the entity 13.

Please note that the above description is related to the situation that the processor 113 determines that the mapping record 10 has expired. However, if the processor 113 determines that the mapping record 10 has not expired according to the live time stamp T1 of the mapping record 10, the processor 113 will not perform the discovery of the network function (i.e., does not need to send the discovery request 134 and receive the discovery response 136) but directly redirect the service request 132 of the entity 13 to the network function publisher (i.e., the entity 17) recorded in the mapping record 10. The details are not repeated herein.

It is noted that, in this embodiment, the processor 113 finds out the mapping record 10 and then determines whether the mapping record 10 has expired after receiving the service request 132. In other embodiments, the processor 113 may periodically or non-periodically determine whether each mapping record has expired according to the live time stamp of the mapping record. In other words, the time to determine whether a mapping record has expired is not limited by the present invention.

According to the above description, the service communication proxy apparatus 11 may delete the expired mapping record(s) in time according to the live time stamp of each mapping record. In this way, the timeliness and correctness of the mapping records stored by the service communication proxy apparatus 11 can be ensured.

Please refer to FIG. 1A and FIG. 4 for a fourth embodiment of the present invention, wherein FIG. 4 depicts the schematic view of the signal transmission in this embodiment. The fourth embodiment is similar to the first embodiment. However, in this embodiment, each mapping record further comprises a maintenance time stamp. Therefore, in this embodiment, the processor 113 of the service communication proxy apparatus 11 will determine whether a mapping record needs to be updated according to the maintenance time stamp of the mapping record. If the processor 113 determines that a mapping record needs to be updated, the processor 113 performs discovery for the network function publisher recorded by the mapping record and thereby determines whether to delete the mapping record or update the maintenance time stamp. The following description will focus on the differences between the fourth embodiment and the first embodiment.

Herein, it is assumed that the service communication proxy apparatus 11 has redirected the service response 108 replied by the entity 17 to the entity 13 in response to the service request 100 made by the entity 13. In this embodiment, the processor 113 periodically or non-periodically checks whether the mapping records stored in the storage 111 need to be updated.

Herein, it is assumed that the processor 113, at a certain time, determines that the mapping record 10 needs to be updated according to the maintenance time stamp T2 included in the mapping record 10. It shall be noted that the form of the maintenance time stamp T2 is not limited by the present invention. For example, the maintenance time stamp T2 may be a preset length of time. Thus, if the processor 113 determines that the mapping record 10 has been stored in the storage 111 for more than the preset length of time, it means that the mapping record 10 needs to be updated. As another example, the maintenance time stamp T2 may be an expiration time point. In that case, if the processor 113 determines that the current time point is later than the expiration time point, it means that the mapping record 10 needs to be updated.

Since the processor 113 determines that the mapping record 10 needs to be updated according to the maintenance time stamp T2 of the mapping record 10, the processor 113 sends a discovery request 142 related to the entity 17 (i.e., the network function publisher recorded in the mapping record 10) to the entity 15 to learn whether the entity 17 is still valid. Next, the processor 113 receives a discovery response 144 related to the entity 17 from the entity 15, wherein the discovery response 144 is used to indicate whether the entity 17 is valid. If the processor 113 determines that the entity 17 is still valid according to the discovery response 144, the processor 113 updates the maintenance time stamp T2 of the mapping record 10. If the processor 113 determines that the entity 17 has become invalid according to the discovery response 144, the processor 113 deletes the mapping record 10 from the storage 111.

Thereafter, if the entity 13 makes a service request for the same network function again, the service communication proxy apparatus 11 will act differently depending on whether the mapping record 10 is still stored in the storage 111. Generally speaking, if the mapping record 10 is still stored in the storage 111, the processor 113 redirects the service request to the entity 17 according to the mapping record 10 and redirects the service response from the entity 17 to the entity 13. The details will not be repeated herein. If the mapping record 10 is not stored in the storage 111 and no other mapping record in the storage 111 is related to both the entity 13 and the network function, the processor 113 performs discovery for the network function again, redirects the service request to a network function publisher according to the result of the discovery, and redirects the service response from the network function publisher to the entity 13. The details will not be repeated herein.

According to the above description, the service communication proxy apparatus 11 may update or delete the mapping records in time according to the maintenance time stamp of each mapping record. In this way, the timeliness and the correctness of the mapping records stored by the service communication proxy apparatus 11 can be ensured.

It shall be noted that, in some embodiments of the present invention, the service communication proxy apparatus 11 may configure a live time stamp and a maintenance time stamp for each mapping record. According to the descriptions of the above embodiments, a person having ordinary skill in the art shall appreciate the operations performed by the service communication proxy apparatus 11 when each mapping record comprises both a live time stamp and a maintenance time stamp. Thus, the details will not be further described herein.

A fifth embodiment of the present invention is a service communication proxy method, whose main flowchart is depicted in FIG. 5A. The service communication proxy method is adapted for use in an electronic computing apparatus belonging to a core network. More specifically, the electronic computing apparatus belongs to a core network of a fifth generation of mobile communication system.

In step S501, the electronic computing apparatus receives a service request from a first entity in the core network, wherein the first entity may be realized by software or hardware. In step S503, the electronic computing apparatus determines (e.g., inquiries the electronic computing apparatus) whether any mapping record is related to both the first entity and a network function indicated by the service request.

If the determination result of the step S503 is no, step S505 is then executed by the electronic computing apparatus to send a discovery request to a second entity of the core network in response to the network function indicated by the service request. The second entity has a network repository function, and the second entity may be realized by software or hardware. Next, in step S507, the electronic computing apparatus receives a discovery response related to the network function from the second entity. The discovery response records an identity message, and the identity message is used to identify a third entity in the core network. The third entity may be realized by software or hardware. The discovery response recording the identity message of the third entity means the third entity providing the network function. In step S509, the electronic computing apparatus records a mapping record regarding the first entity and the third entity. In step S511, the electronic computing apparatus redirects the service request to the third entity according to the identity message. In step S513, the electronic computing apparatus receives a service response from the third entity. In step S515, the electronic computing apparatus redirects the service response to the first entity.

If the determination result of the step S503 is yes, the electronic computing apparatus finds out the mapping record. Next, the electronic computing apparatus executes steps S511, S513, and S515 according to the mapping record.

In some embodiments, the service communication proxy method also executes the flowchart shown in FIG. 5B to timely delete the mapping records related to invalid network function publisher(s). Specifically, in step S521, the electronic computing apparatus receives a notification message from the second entity, wherein the notification message indicates that a certain entity (e.g., the aforesaid third entity) is invalid. In step S523, the electronic computing apparatus determines whether any mapping record in the electronic computing apparatus is related to the entity recorded in the notification message. If the determination result of the step S523 is yes, step S525 is executed by the electronic computing apparatus to delete the mapping record related to the entity recorded in the notification message. For example, if the notification message records the aforesaid third entity, the step S525 deletes the mapping record regarding the first entity and the third entity that is recorded previously. Thereafter, the service communication proxy method ends the processing flow related to the notification message.

In some embodiments, each mapping record recorded by the service communication proxy method further comprises a live time stamp. In these embodiments, the service communication proxy method further executes a step to determine whether a mapping record has expired by the electronic computing apparatus according to the live time stamp of the mapping record. If the mapping record has expired, the service communication proxy method further executes a step to delete the mapping record by the electronic computing apparatus.

In some embodiments, the service communication proxy method also executes the flowchart shown in FIG. 5C to update or delete the mapping record in time. In these embodiments, each mapping record recorded by the service communication proxy method further comprises a maintenance time stamp.

Specifically, in step S531, the electronic computing apparatus determines that a mapping record needs to be updated according to the maintenance time stamp of the mapping record. In step S533, the electronic computing apparatus sends a discovery request related to a network function publisher (which is an entity in the core network) recorded in the mapping record to the second entity. In step S535, the electronic computing apparatus receives a discovery response related to the network function publisher from the second entity. In step S537, the electronic computing apparatus determines whether the network function publisher is still valid according to the discovery response. If the determination result of the step S537 is that the network function publisher is still valid, step S539 is executed to update the maintenance time stamp of the mapping record by the electronic computing apparatus. If the determination result of the step S537 is that the network function publisher has become invalid, step S541 is executed to delete the mapping record by the electronic computing apparatus.

In addition to the aforesaid steps, the fifth embodiment can also execute all the operations and steps that can be executed by the service communication proxy apparatus 11 set forth in the first to fourth embodiments, have the same functions, and deliver the same technical effects as the first to fourth embodiments. How the fifth embodiment executes these operations and steps, has the same functions, and delivers the same technical effects as the first to fourth embodiments will be readily appreciated by a person having ordinary skill in the art based on the descriptions of the first to fourth embodiments, and thus will not be further described herein.

It shall be noted that, in the above embodiments, if each entity is individually realized by hardware, each entity will comprise at least one transceiving interface for transceiving signals. In addition, in the above embodiments, each discovery request may be realized by the “NF Discovery Request” signal in the fifth generation of mobile communication system, while each discovery response may be realized by the “NF Discovery Response” signal in the fifth generation of mobile communication system.

It shall be noted that, in the specification and the claims of the present application, some words (including entity, service request, service response, discovery request, discovery response, identity message, mapping record) are preceded by the terms “first,” “second,” or “third” and these terms “first,” “second,” or “third” are only used to distinguish these are different words.

According to the above descriptions, the service communication proxy technology (at least including the apparatus and the method) provided by the present invention stores a mapping record regarding a network function consumer (e.g., the aforementioned first entity) and a network function publisher (e.g., the aforementioned third entity). If the network function consumer makes a service request for the same network function again, the service communication proxy technology provided by the present invention directly redirects the service request to the corresponding network function publisher according to the previously stored mapping record. Additionally, the service communication proxy technology provided by the present invention may update and/or delete the mapping record in time by using the notification message, the live time stamp, and/or the maintenance time stamp and thereby ensure the timeliness and correctness of the stored mapping record(s). By storing the mapping record regarding the network function consumer and the network function publisher, the service communication proxy technology provided by the present invention does not need to frequently interact with the network repository function. Thereby, the communication load between the entities in the core network is reduced and the communication delay between the entities in the core network is mitigated. As a result, the performance of the core network is improved.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

1. A service communication proxy apparatus, comprising:
a storage; and
a processor, being electrically connected to the storage and configured to receive a first service request from a first entity in a core network and send a first discovery request to a second entity in the core network in response to a network function indicated in the first service request, wherein the second entity has a network repository function (NRF),
wherein the processor further receives a first discovery response related to the network function from the second entity, redirects the first service request to a third entity in the core network according to a first identity message indicated in the first discovery response, receives a first service response from the third entity, records a first mapping record regarding the first entity and the third entity in the storage, and redirects the first service response to the first entity,
wherein the processor further receives a second service request from the first entity, the second service request indicates the network function, the processor further finds out that the first mapping record in the storage is related to the first entity and the third entity having the network function, the processor further redirects the second service request to the third entity, the processor further receives a second service response from the third entity, and the processor further redirects the second service response to the first entity.

2. (canceled)

3. The service communication proxy apparatus of claim 1, wherein the processor further receives a notification message from the second entity, the notification message indicates that the third entity is invalid, and the processor further deletes the first mapping record regarding the first entity and the third entity from the storage.

4. The service communication proxy apparatus of claim 3, wherein the processor further receives a third service request from the first entity, the third service request indicates the network function, the processor further finds out that no mapping record in the storage is related to both the first entity and the network function, the processor further sends a second discovery request to the second entity in response to the network function indicated in the third service request, the processor further receives a second discovery response related to the network function from the second entity, the processor further redirects the third service request to a fourth entity in the core network according to a second identity message indicated in the second discovery response, the processor further receives a third service response from the fourth entity, the processor further records a second mapping record regarding the first entity and the fourth entity in the storage, and the processor further redirects the third service response to the fourth entity.

5. The service communication proxy apparatus of claim 1, wherein the first mapping record further comprises a live time stamp, the processor further determines that the first mapping record has expired according to the live time stamp, and the processor further deletes the first mapping record from the storage after determining that the first mapping record has expired.

6. The service communication proxy apparatus of claim 5, wherein the processor further receives a third service request from the first entity, the third service request indicates the network function, wherein the processor finds out that the first mapping record in the storage is related to the first entity and the third entity having the network function after receiving the third service request and then determines that the first mapping record has expired according to the live time stamp included in the first mapping record.

7. The service communication proxy apparatus of claim 1, wherein the first mapping record further comprises a maintenance time stamp, the processor further determines that the first mapping record needs to be updated according to the maintenance time stamp, the processor further sends a second discovery request related to the third entity to the second entity, the processor further receives a second discovery response related to the third entity from the second entity, the processor further determines that the third entity is still valid according to the second discovery response, and the processor updates the maintenance time stamp based on the determination result that the third entity is still valid.

8. The service communication proxy apparatus of claim 1, wherein the first mapping record further comprises a maintenance time stamp, the processor further determines that the first mapping record needs to be updated according to the maintenance time stamp, the processor further sends a second discovery request related to the third entity to the second entity, the processor further receives a second discovery response related to the third entity from the second entity, the processor further determines that the third entity has become invalid according to the second discovery response, and the processor deletes the first mapping record based on the determination result that the third entity has become invalid.

9. A service communication proxy method, comprising:
receiving a first service request from a first entity in a core network;
sending a first discovery request to a second entity in the core network in response to a network function indicated in the first service request, wherein the second entity has a network repository function;
receiving a first discovery response related to the network function from the second entity;
redirecting the first service request to a third entity in the core network according to a first identity message indicated in the first discovery response;
receiving a first service response from the third entity;
recording a first mapping record regarding the first entity and the third entity in an electronic computing apparatus;
redirecting the first service response to the first entity;
receiving a second service request from the first entity, wherein the second service request indicates the network function;
finds out that the first mapping record in the electronic computing apparatus is related to the first entity and the third entity having the network function;
redirecting the second service request to the third entity;
receiving a second service response from the third entity; and
redirecting the second service response to the first entity.

10. (canceled)

11. The service communication proxy method of claim 9, further comprising:
receiving a notification message from the second entity, wherein the notification message indicates that the third entity is invalid; and
deleting the first mapping record regarding the first entity and the third entity from the electronic computing apparatus.

12. The service communication proxy method of claim 11, further comprising:
receiving a third service request from the first entity, wherein the third service request indicates the network function;
finding out that no mapping record in the electronic computing apparatus is related to both the first entity and the network function;
sending a second discovery request to the second entity in response to the network function indicated in the third service request;
receiving a second discovery response related to the network function from the second entity;
redirecting the third service request to a fourth entity in the core network according to a second identity message indicated in the second discovery response;
receiving a third service response from the fourth entity;
recording a second mapping record regarding the first entity and the fourth entity in the electronic computing apparatus; and
redirecting the third service response to the fourth entity.

13. The service communication proxy method of claim 9, wherein the first mapping record further comprises a live time stamp, and the service communication proxy method further comprises:
determining that the first mapping record has expired according to the live time stamp; and
deleting the first mapping record from the electronic computing apparatus after determining that the first mapping record has expired.

14. The service communication proxy method of claim 13, further comprising:
receiving a third service request from the first entity, wherein the third service request indicates the network function;
wherein the service communication proxy method finds out that the first mapping record in the electronic computing apparatus is related to the first entity and the third entity having the network function and then determines that the first mapping record has expired according to the live time stamp included in the first mapping record.

15. The service communication proxy method of claim 9, wherein the first mapping record further comprises a maintenance time stamp, and the service communication proxy method further comprises:
determining that the first mapping record needs to be updated according to the maintenance time stamp;
sending a second discovery request related to the third entity to the second entity;
receiving a second discovery response related to the third entity from the second entity;
determining that the third entity is still valid according to the second discovery response; and
updating the maintenance time stamp based on the determination result that the third entity is still valid.

16. The service communication proxy method of claim 9, wherein the first mapping record further comprises a maintenance time stamp, and the service communication proxy method further comprises:
determining that the first mapping record needs to be updated according to the maintenance time stamp;
sending a second discovery request related to the third entity to the second entity;
receiving a second discovery response related to the third entity from the second entity;
determining that the third entity has become invalid according to the second discovery response; and
deleting the first mapping record based on the determination result that the third entity has become invalid.
